(19) United States
(12) Patent Application Publication
(10) Pub. No.: US 2026/0161011 A1
(43) Pub. Date: Jun. 11, 2026

(54) METHOD AND DEVICE FOR TRACKING EYEBALLS, DISPLAY DEVICE, DEVICE, AND MEDIUM

(71) Applicants: Beijing BOE Display Technology Co., Ltd., Beijing (CN); BOE Technology Group Co., Ltd., Beijing (CN)

(72) Inventors: Chenru WANG, Beijing (CN); Hao ZHANG, Beijing (CN); Lili CHEN, Beijing (CN); Ruijun DONG, Beijing (CN); Yulong WU, Beijing (CN); Na HAN, Beijing (CN); Jiarong BAI, Beijing (CN); Haitao HUANG, Beijing (CN); Aodi MIAO, Beijing (CN)

(21) Appl. No.: 18/704,433

(22) PCT Filed: Jul. 28, 2023
(86) PCT No.: PCT/CN2023/110036

§ 371 Date: Apr. 24, 2024

(30) Foreign Application Priority Data
Aug. 25, 2022 (CN) 202211027322.6

(51) Int. Cl. G02B 30/26; G06F 3/01

(52) U.S. Cl. CPC G02B 30/26; G06F 3/013

(57) ABSTRACT

Provided is a method and device for tracking eyeballs, a display device, a device, and a medium. The device for tracking eyeballs includes a distance detecting unit, a light emitting unit, a light detecting unit, and a processing unit; wherein the distance detecting unit is configured to detect a first distance between an eyeball to a target object; the light emitting unit is configured to irradiate a target eyebox region of the target object with infrared light; the light detecting unit includes a plurality of sub-units arranged in an array, wherein each of the plurality of sub-units includes a plurality of receivers; and the processing unit is configured to control a first receiver in each of the plurality of sub-units to receive the infrared light reflected by the eyeball and determine a position of the eyeball based on an intensity of the infrared light received by the first receiver.

This application is a U.S. national stage of international application No. PCT/CN2023/110036, filed on Jul. 28, 2023, which claims priority to Chinese Patent Application No. 202211027322.6, filed on Aug. 25, 2022 and entitled “EYEBALL TRACKING DEVICE AND METHOD, DISPLAY, EQUIPMENT AND MEDIUM,” the disclosures of which are herein incorporated by references in their entireties.

### TECHNICAL FIELD

The present disclosure relates to the field of human-computer interaction technologies, in particular to a method and device for tracking eyeballs, a display device, a device, and a medium.

### BACKGROUND

A device for tracking eyeballs is used to detect a position of an eyeball of a viewer to cause a target object to be changed based on the position of the eyeball.

The device for tracking eyeball includes a light emitting unit, an infrared camera, and a processing unit. The light emitting unit is configured to emit infrared light to a region of the eyeball, the infrared camera is configured to receive infrared light reflected by the eyeball and image, and the processing unit is configured to determine the position of the eyeball based on an image generated by the infrared camera.

### SUMMARY

Embodiments of the present disclosure provide a method and device for tracking eyeballs, a display device, a device, and a medium. The technical solutions are as follows.

In some embodiments of the present disclosure, a device for tracking eyeballs is provided. The device for tracking eyeballs incudes: a distance detecting unit, a light emitting unit, a light detecting unit, and a processing unit. The distance detecting unit is configured to detect a first distance between an eyeball to a target object; the light emitting unit is configured to irradiate a target eyebox region of the target object with infrared light; the light detecting unit includes a plurality of sub-units arranged in an array, wherein each of the plurality of sub-units includes a plurality of receivers arranged in an array, the plurality of receivers being configured to receive infrared light reflected by the eyeball; and the processing unit is configured to control a first receiver in each of the plurality of sub-units to receive the infrared light reflected by the eyeball and determine a position of the eyeball based on an intensity of the infrared light received by the first receiver, wherein the first receiver is a receiver corresponding to the first distance.

In some embodiments, each of the plurality of receivers includes a diaphragm and an infrared light sensor, wherein the diaphragm is configured to control whether to allow the infrared light to enter the corresponding infrared light sensor under the control of the processing unit.

In some embodiments, the diaphragm is a liquid crystal diaphragm or a micro electron scanning microscope.

In some embodiments, each of the plurality of sub-units comprises an equal number of receivers with the same arrangement pattern, and in at least two of the plurality of sub-units, arrangement positions of the receivers corresponding to the same distance are the same or different.

In some embodiments, each of the plurality of sub-units further includes a micro-lens configured to converge the infrared light reflected by the eyeball to the first receiver in the each of the plurality of sub-units.

In some embodiments, each of the plurality of sub-units further includes a light blocking structure disposed between any two adjacent receivers of the plurality of receivers.

In some embodiments, the target eyebox region includes a plurality of sub-regions arranged in an array; and the processing unit is configured to determine a position of a pupil of the eyeball based on the intensity of the infrared light received by the first receiver, and determine a target sub-region corresponding to the sub-unit of the position of the pupil as the position of the eyeball based on a corresponding relationship of the plurality of sub-units and the plurality of sub-regions.

In some embodiments, the processing unit is configured to determine a position of the first receiver meeting the following conditions as the position of the pupil: the intensity of the received infrared light is less than a first light intensity threshold, and a plurality of first receivers with the intensity of the received infrared light greater than a second light intensity threshold are disposed around the first receiver with the intensity of the received infrared light being less than the first light intensity threshold.

In some embodiments, the processing unit is further configured to control a second receiver in the each of the plurality of sub-units to not receive the infrared light reflected by the eyeball, wherein the second receiver is a receiver other than the first receiver.

In some embodiments, the target object includes a display screen and is provided with a plurality of eyebox regions arranged in a direction parallel to a horizontal central line of the display screen, and the target eyebox region is one of the plurality of eyebox regions; and the processing unit is further configured to determine the target eyebox region based on an eye portion position corresponding to the eyeball.

In some embodiments of the present disclosure, a method for tracking eyeballs is provided. The method for tracking eyeballs incudes: acquiring a first distance between an eyeball and a target object; controlling a first receiver in each of a plurality of sub-units to receive infrared light reflected by the eyeball, wherein the plurality of sub-units are arranged in an array, each of the plurality of sub-units includes a plurality of receivers arranged in an array, and the first receiver is a receiver in the each of the plurality of sub-units corresponding to the first distance; and determining a position of the eyeball based on an intensity of the infrared light received by the first receiver.

In some embodiments, the target eyebox region includes a plurality of sub-regions arranged in an array; and determining the position of the eyeball based on the intensity of the infrared light received by the first receiver includes: determining a position of a pupil of the eyeball based on the intensity of the infrared light received by the first receiver; and determining a target sub-region corresponding to the sub-unit of the position of the pupil as the position of the eyeball based on a corresponding relationship of the plurality of sub-units and the plurality of sub-regions.

In some embodiments, determining the position of the pupil of the eyeball based on the intensity of the infrared light received by the first receiver includes: determining a position of the first receiver meeting the following conditions as the position of the pupil: the intensity of the received infrared light is less than a first light intensity threshold, and a plurality of first receivers with the intensity of the received infrared light greater than a second light intensity threshold are disposed around the first receiver with the intensity of the received infrared light being less than the first light intensity threshold.

In some embodiments, the target object includes a display screen and is provided with a plurality of eyebox regions arranged in a direction parallel to a horizontal central line of the display screen, and the target eyebox region is one of the plurality of eyebox regions; and the method further includes: determining the target eyebox region based on an eye portion position corresponding to the eyeball.

In some embodiments of the present disclosure, a display device is provided. The display device incudes: a display screen and any above device for tracking eyeball, wherein the light emitting unit and the light detecting unit are disposed on a periphery of a display region of the display screen.

In some embodiments, the display device is an autostereoscopic display, an augmented reality AR device, or a virtual reality VR device.

In some embodiments, the light emitting unit includes a plurality of light emitting diodes LED arranged at intervals around the display region of the display screen.

In some embodiments, the light detecting unit is disposed on a central position of a first side edge of the display screen.

In some embodiments of the present disclosure, a computer device is provided. The computer device incudes: a processor and a memory configured to store a computer program, wherein the processor, when loading and running the computer program in the memory, is caused to perform any above method for tracking eyeballs.

In some embodiments of the present disclosure, a computer-readable storage medium is provided. The storage medium incudes at least one instruction, wherein the at least one instruction, when loaded and executed by a processor, causes the processor to perform any above method for tracking eyeballs.

In some embodiments of the present disclosure, a computer program product is provided. The computer program product incudes computer programs. Wherein the computer programs, when loaded and run by a processor, cause the processor to perform any above method for tracking eyeballs.

### BRIEF DESCRIPTION OF DRAWINGS

For clearer description of the technical solutions in the embodiments of the present disclosure, the following briefly describes the accompanying drawings required for describing the embodiments. Apparently, the accompanying drawings in the following description show merely some embodiments of the present disclosure, and those of ordinary skill in the art may still derive other drawings from these accompanying drawings without any creative efforts.

FIG. 1 is a schematic structural diagram of a device for tracking eyeballs according to some embodiments of the present disclosure;

FIG. 2 is a schematic diagram of a light detecting unit according to some embodiments of the present disclosure;

FIG. 3 is a schematic diagram of a relationship of an eyebox region and a display device according to some embodiments of the present disclosure;

FIG. 4 is a section view of a partial structure of a sub-unit according to some embodiments of the present disclosure;

FIG. 5 is a schematic diagram of an eye;

FIG. 6 is a schematic diagram of a working process of a device for tracking eyeballs according to some embodiments of the present disclosure;

FIG. 7 to FIG. 9 are schematic diagram of working principles of a device for tracking eyeballs at different distances according to some embodiments of the present disclosure;

FIG. 10 is a flowchart of a method for tracking eyeballs according to some embodiments of the present disclosure;

FIG. 11 is a schematic structural diagram of an apparatus for tracking eyeballs according to some embodiments of the present disclosure; and

FIG. 12 is a schematic structural diagram of a computer device according to some embodiments of the present disclosure.

### DETAILED DESCRIPTION

To make the objectives, technical solutions, and advantages of the present disclosure clearer, the embodiments of the present disclosure are further described in detail hereinafter with reference to the accompanying drawings.

The device for tracking eyeballs is used to detect the position of the eyeballs to correspondingly change the position of the eyeballs by the target object. The target object is a product with a display function, for example, an autostereoscopic (three-dimensional) display, an augmented reality (AR) device, a virtual reality (VR) device, a head up display (HUD), a mobile terminal (such as a mobile phone, a tablet computer, and a notebook), and the like. The products are used to control contents to change based on the position of the eyeball. Alternatively, the target object is a product performing some actions based on the instructions of the user, for example, a robot, and the like. Such products perform corresponding actions based on the position of the eyeball, and the type of the target object is not limited in the embodiments of the present disclosure.

In some practices, the device for tracking eyeballs includes a light emitting unit, an infrared camera, and a processing unit. The light emitting unit is configured to emit infrared light to a region of the eyeball, the infrared camera is configured to receive infrared light reflected by the eyeball and image, and the processing unit is configured to determine the position of the eyeball based on an image generated by the infrared camera. The photosensitive chip of the infrared camera includes a plurality of infrared light sensors arranged in an array, and all infrared light sensors detect the intensity of the infrared light reflected by the eyeballs simultaneously to form an image. The processing unit requires to process data detected by all infrared light sensors. An amount of the data is great, the processing capability of the processing unit requires to be great, and the response speed is slow.

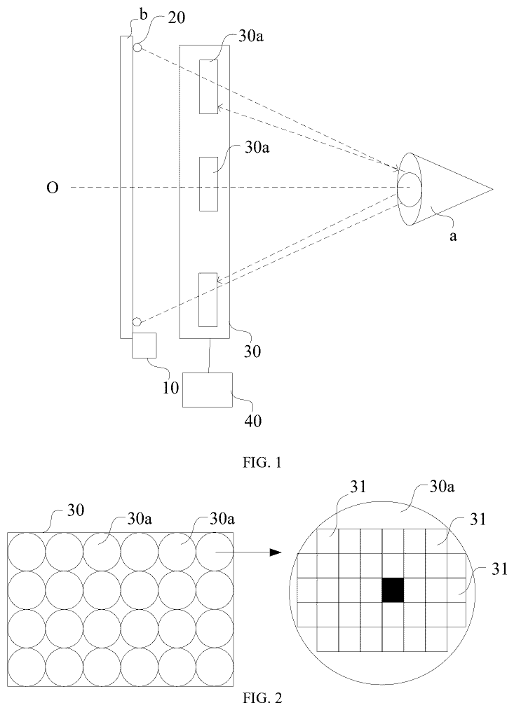

Thus, the embodiments of the present disclosure provide a device for tracking eyeball. FIG. 1 is a schematic structural diagram of a device for tracking eyeballs according to some embodiments of the present disclosure. As shown in FIG. 1, the device for tracking eyeballs includes a distance detecting unit 10, a light emitting unit 20, a light detecting unit 30, and a processing unit 40. The distance detecting unit 10 is configured to detect a first distance between an eyeball a and a target object b, and the light emitting unit 20 is configured to irradiate a target eyebox region of the target object b with infrared light.

FIG. 2 is a schematic diagram of a light detecting unit according to some embodiments of the present disclosure. In conjunction with FIG. 1 and FIG. 2, the light detecting unit 30 includes a plurality of sub-units 30a arranged in an array, any of the plurality of sub-units includes a plurality of receivers 31 arranged in an array, and the plurality of receivers 31 are configured to receive the infrared light reflected by the eyeball. The processing unit 40 is configured to control a first receiver (a black block in FIG. 2) in each of the plurality of sub-units 30a to receive the infrared light reflected by the eyeball and determine a position of the eyeball based on an intensity of the infrared light received by the first receiver, and the first receiver is a receiver corresponding to the first distance.

The first server corresponding to the first distance is selected based on the first distance between the eyeball and the target object to receive the infrared light reflected by the eyeball, and the processing unit determines the position of the eyeball based on the intensity of the infrared light received by the first receiver. Compared with the case that all receivers receive the infrared light simultaneously, and the processing unit images based on the intensity of the infrared light received by the receivers and determines the position of the eyeball by processing the image, the determination of the position of the eyeball based on the intensity of the infrared light received by the first receivers has the less amount of the processed data, a less requirement for processing capability of the processing unit, and the improved response speed of the target object.

In the embodiments of the present disclosure, the eyebox region indicates a moving range of the eyeball in the case that the user views or controls the target object. In the case that the target object is the display device and the eyeball moves within the eyebox region, the user views a complete screen displayed by the display device. In the case that the target object is a robot or other action performers and the eyeball moves within the eyebox region, as long as the target object receives the infrared light reflected by the eyeball.

Illustratively, the eyebox region is a three-dimensional special region, and is in a cuboid shape, a cylindrical shape, or an elliptic cylindrical shape, and the like.

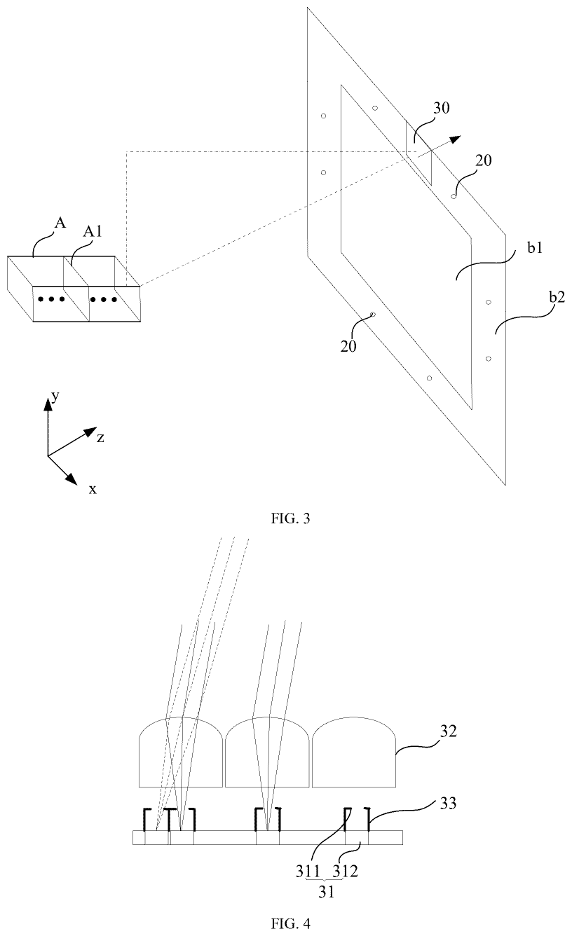

FIG. 3 is a schematic diagram of a relationship of an eyebox region and a display device according to some embodiments of the present disclosure. As shown in FIG. 3, in the case that the eyebox region A is in a cuboid shape, a length direction of the eyebox region A is the same as a length direction of the display screen of the display device as shown in the x direction in FIG. 3, a width direction of the eyebox region A is the same as a width direction of the display screen of the display device as shown in the y direction in FIG. 3, and a height direction of the eyebox region A is the same as an optical axis direction of the display screen of the display device as shown in the z direction in FIG. 3.

In some embodiments, the length direction is a horizontal direction, the width direction is a vertical direction, and the height direction is perpendicular to the horizontal direction and the vertical direction.

For some display devices with less viewing ranges, one display screen has one eyebox region, and the eyebox region is the target eyebox region. For example, a head-mounted display device (for example, the VR or AR device) includes two display screens, one display screen is for the viewing of the left eye, the other display screen is for the viewing of the right eye, and each display screen has one eyebox region. Illustratively, a central line of the vertical direction of the eyebox region, a central line of the vertical direction of the display screen and the optical axis of the display screen are coplanar.

For some display device with greater viewing ranges, one display screen has several eyebox regions, and the target eyebox region is one of the several eyebox regions. For example, for an autostereoscopic display and the like, one display screen is for the viewing of two eyes, and the moving range of the viewer is greater relative to the display screen and is generally from left side to right side of the display screen. In this case, the viewing range is divided into a plurality of eyebox regions arranged in a direction parallel to a horizontal central line of the display screen, and the eyebox region corresponding to the position of the left eye or right eye of the viewer is the target eyebox region. As the left eye and the right eye of the human are always moves simultaneously, one of the eyes is selected to detect the position of the eye.

In the embodiments of the present disclosure, a number of the sub-units in the light detecting unit is set as required. For example, 24 sub-units are set, and the 24 sub-units are arranged in four rows and six columns. It should be noted that the arrangement pattern shown in FIG. 2 is exemplary, which is not limited in the present disclosure.

In the embodiments of the present disclosure, the distance detecting unit 10 includes a depth camera, a laser distance detector or an infrared distance sensor, and the like. In some embodiments, the distance detecting unit 10 is integrated in the target object b. In some embodiments, the distance detecting unit 10 is disposed on a periphery of the display region of the display device, for example, integrated on a frame of the display device, and the like. Illustratively, a detecting precision of the distance detecting unit 10 is in a millimeter scale.

The eyebox region is divided into a plurality of eyebox sub-region A1 in a direction from the eyeball to the display screen, that is, the eyebox region is divided into a plurality of eyebox sub-region A1 based on the distance between the eyeball and the display screen. The eyebox sub-region A1 corresponds to different distances.

For avoiding the effect on the detecting result caused by the direct entry of the infrared light emitted by the light emitting unit to the receiver, as shown in FIG. 1, the light detecting unit 30 is disposed between the eyebox region and the light emitting unit 20 in a viewing direction of the user or an optical axis O direction of the display device.

In some embodiments, the light emitting unit 20 includes a plurality of light emitting devices, for example, infrared light emitting diodes (LED), and the like. A wavelength of the infrared light emitting by the light emitting device ranges from 800 to 1200 nm. As shown in FIG. 3, the plurality of light emitting devices are arranged at intervals around the display region b1 of the display device in the case that the target object b is the display device.

In some embodiments, the light emitting device is integrated in the display screen of the display device. For example, the light emitting device is disposed in the non-display region b2 of the display screen, and the light emitting device and the light emitting unit in the display region of the display screen are manufactured simultaneously. For example, the light emitting device is disposed on the frame of the display device. For further example, the light emitting device is disposed in other parts (such as the gantry of the head up display, and the like) around the display screen.

In the case that the target object is the display device, the light detecting unit 30 is disposed on a central position of a first side edge of the display screen, and the first side edge is a top edge or a bottom edge. For example, in FIG. 3, the light detecting unit 30 is disposed on a central position of the top edge of the display screen. As the user generally views the display screen at the central position of the display screen, the light detecting unit is disposed on the central position of the first side edge to facilitate the detection of the position of the eyeball.

In the embodiments of the present disclosure, each of the plurality of sub-units 30a includes an equal number of the receivers 31 with the same arrangement pattern, that is, the plurality of receivers 31 in one sub-unit 30a can be acquired by translating the plurality of receivers 31 in another sub-unit 30a. Illustratively, all receivers 31 in the sub-units 30a are arranged in an array. The arrangement in the array is in one array, for example, 36 receivers 31 are arranged in four rows and nine columns. Alternatively, the arrangement in the array is composed of a plurality of sub-arrays. For example, as shown in FIG. 2, each sub-unit 30a includes 36 receivers arranged in five rows, the first row and the last row respectively include six receivers (the first row and the last row are respectively one sub-array), and the central three rows respectively include eight receivers (the central three rows are one sub-array).

In the embodiments of the present disclosure, different receivers 31 in each sub-unit 30a correspond to different distances. In two sub-units 30a, two receivers 31 corresponding to the same distance are in different arrangement positions. For example, the receive corresponding to the first distance in the first sub-unit is disposed on the first in the first row, and the receive corresponding to the first distance in the second sub-unit is disposed on the second in the second row. Alternatively, in two sub-units 30a, two receivers 31 corresponding to the same distance are in the same arrangement position. The arrangement positions of the receivers corresponding to the same distance in different sub-units are determined by the optical paths of the infrared light reflected by the eyeball, as long as each sub-unit includes the receiver capable of receiving the infrared light reflected by the eyeball at different distances.

FIG. 4 is a section view of a partial structure of a sub-unit according to some embodiments of the present disclosure. As shown in FIG. 4, the receiver 31 includes a diaphragm 311 and an infrared light sensor 312, and each diaphragm 311 corresponds to one infrared light sensor 312. The diaphragm 311 is configured to control whether to allow the infrared light reflected by the eyeball to enter the corresponding infrared light sensor 312. Illustratively, the diaphragm 311 and the corresponding infrared light sensor 312 are arranged sequentially in the direction parallel to the optical axis of the display screen.

In some embodiments, the diaphragm 311 is a liquid crystal diaphragm. The processing unit is electrically connected to the electrode of the liquid crystal diaphragm and generates an electric filed by controlling the voltage supplied on the electrode, and the electric field controls the deflecting direction of the liquid crystal in the liquid crystal diaphragm to control the transmittance of the liquid crystal diaphragm. In the case that the transmittance of the liquid crystal diaphragm is greatest, the diaphragm is in an on state, and the infrared light reflected by the eyeball is detected by the corresponding infrared light sensor. In the case that the transmittance of the liquid crystal diaphragm is lowest, the diaphragm is in an off state, and the infrared light reflected by the eyeball is not detected by the corresponding infrared light sensor.

In some embodiments, the diaphragm 311 is a micro electron scanning microscope. The micro electron scanning microscope is also referred to as a micro electromechanical system (MEMS) microscope. The micro electron scanning microscope includes a plurality of microscopes, and each microscope belongs to one receiver and is driven by one micro motor. The processing unit drives the micro motor to rotate by supplying the voltage to the micro motor, such that the corresponding microscope is driven to rotate. In the case that the microscope is parallel to the display face of the display screen, the microscope reflects the infrared light reflected by the eyeball to the light detecting unit. In this case, the diaphragm is in an off state, and the infrared light reflected by the eyeball is not detected by the corresponding infrared light sensor. In the case that the microscope and the display face of the display screen form an included angle, the diaphragm is in an on state, and at least part of the infrared light reflected by the eyeball to the light detecting unit is irradiated to the corresponding infrared light sensor and is not detected by the corresponding infrared light sensor.

In some implementations, the liquid crystal diaphragm or the micro electron scanning microscope is attached to the glass cover plate of the display screen.

In some embodiments, the infrared light sensor 312 is directly manufactured on the display substrate of the display screen. For example, the infrared light sensor and the light emitting device in the display region of the display screen are manufactured simultaneously, or the infrared light sensor is manufactured prior to or upon manufacturing the light emitting device in the display region of the display screen. By integrating the infrared light sensor on the display substrate, the device for tracking eyeballs and the display screen are integrated, and the volume of the display device is reduced.

In some embodiments, all infrared light sensors of the plurality of sub-units are integrated in one chip and then fixed on the glass cover plate of the display screen.

In some embodiments, each sub-unit 30a further includes a micro-lens 32 configured to converge the infrared light reflected by the eyeball at the first distance to the first receiver in the corresponding sub-unit 30a. In some embodiments, the micro-lenses 32 in the plurality of sub-units 30a are of an integrated structure or a split structure.

Illustratively, the micro-lens 32 is a solid lens or a non-solid lens. In the case that the micro-lens 32 is the solid lens, the micro-lens 32 is manufactured by the glass or resin material. In the case that the lens 32 is the non-solid lens, the micro-lens 32 is manufactured by the liquid crystal or liquid material.

In the case that the micro-lens 32 is the solid lens, the type of the surface of the micro-lens 32 includes, but is not limited to a spherical surface, an aspherical surface, a Fresnel surface, a free-curved surface, and the like.

In some embodiments, the micro-lens 32 is of a single-layer structure or is combined by multi-layer lenses. In the case that the micro-lens is combined by multi-layer lenses, the adjacent lenses are bonded by the glue.

In the embodiments of the present disclosure, the micro-lens 32 is in a micrometer scale, and the infrared light sensor is in a 0.1-micrometer scale.

In the case that the light emitting direction of the light emitting unit, the structure and the related parameters of the micro-lens, the position of the eyebox region relative to the display screen, and the structure of the light detecting unit and the position of the light detecting unit relative to the display screen are determined, the optical path directions of the infrared light reflected at different positions of the eyebox region are simulated by a computer, and the positions of the receivers corresponding to the distances in the sub-units are determined in conjunction with the optical path directions of the infrared light pass through the micro-lenses. For example, assuming that the eyeball is at a position with a certain distance, the propagation path of the infrared light is simulated, and the irradiated receivers of the sub-units are determined as the receivers corresponding to the distance. The receivers corresponding to the distances are determined by traversing all distances.

In the case that not all sub-units include the receivers corresponding to all distances in the current configuration, the type of the surface and other parameters of the micro-lens need to be adjusted.

In some embodiments, the sub-unit further includes a light blocking structure 33 disposed between any two adjacent receivers 31. The light blocking structure 33 can prevent that the light entering the first receiver enters the second receiver adjacent to the first receiver in the propagating process to cause the second receiver to output the signal and affect the accuracy of the detecting result.

Illustratively, the light blocking structure 33 is disposed around at least one of: the diaphragm, the infrared light sensor and the portion between the diaphragm and the infrared light sensor. In the case that the light blocking structure 33 is disposed around the diaphragm, the infrared light sensor and the portion between the diaphragm and the infrared light sensor, the receivers are completely separated to avoid the crosstalk. For simplifying the processes, the light blocking structure is disposed around the diaphragm and/or the portion between the diaphragm and the infrared light sensor.

It should be noted that FIG. 4 only shows a section structure of a portion of the sub-unit, and thus the light blocking structure 33 around the same receiver 31 is separated in FIG. 4.

In some embodiments, the light blocking structure 33 is made of the material with a wide infrared light absorbance wavelength range, which covers the wavelength range from 800 nm to 1200 nm or more wider wavelength range, for example, the material with the same as the screen black matrix (BM) material or other material with the same function.

In the embodiments of the present disclosure, the corresponding relationship of the distance and the receiver is pre-stored in the processing unit 40. Illustratively, in the corresponding relationship, each distance corresponds to one set of identifiers of the receivers, and different distances correspond to different identifiers of the receivers. The identifiers of the receivers are acquired by combining the serial numbers of the sub-units and the positions of the receivers in the sub-units (for example, the serial number of the row and the column). Alternatively, the identifiers of the receivers are acquired by combining the serial numbers of the sub-units and the serial numbers of the receivers in the sub-units.

In the case that the processing unit 40 acquires the first distance, the processing unit 40 determines the first receivers corresponding to the first distance and controls the first receivers to work (that is, receivers the infrared light reflected by the eyeball).

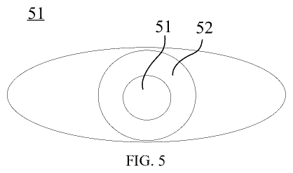

FIG. 5 is a schematic diagram of an eye. As shown in FIG. 5, the eye 50 includes an eyeball, and the eyeball includes a pupil 51 and an iris 52 around the pupil 51. The reflective indexes of the pupil 51 and the iris 52 for the infrared light are different, and the reflective index of the pupil 51 for the infrared light is greatly less than the reflective index of the iris 52 for the infrared light. In the embodiments of the present disclosure, the processing unit 40 identifies the position of the eyeball based on the principle.

In the embodiments of the present disclosure, the eyebox region is divided into a plurality of sub-regions arranged in an array, and the plurality of sub-regions and the plurality of sub-units are in one-to-one correspondence. The resolution of the position of the eyeball detected by the device for tracking eyeballs (that is, the number of the positions of the eyeball detected per unit area) is represented by the number of the sub-regions in the eyebox region. The number of the sub-regions in the eyebox region is limited by the manufacturing precision of the devices in the sub-unit. In the case that the manufacturing precision of the sub-unit is determined, the plurality of sub-regions and the plurality of sub-units are in one-to-one correspondence, such that the resolution of the device for tracking eyeballs is maximum.

Alternatively, in some embodiments, a plurality of sub-units correspond to one sub-region, for example, each two adjacent sub-units in each row or each column correspond to one sub-region, and the like.

The correspondence of the sub-unit and the sub-region herein indicates that the position of the pupil determined based on the infrared light reflected by the eyeball is within the sub-unit corresponding to the sub-region in the case that the eyeball is within the sub-region.

In the embodiments of the present disclosure, the processing unit 40 is configured to determine the position of the pupil of the eyeball based on the intensity of the infrared light received by the first receiver, and determine the target sub-region corresponding to the sub-unit of the position of the pupil as the position of the eyeball based on the corresponding relationship of the plurality of sub-units and the plurality of sub-regions.

Illustratively, the processing unit 40 is configured to determine the position of the first receiver meeting the following conditions as the position of the pupil: the intensity of the received infrared light is less than a first light intensity threshold, and a plurality of first receivers with the intensity of the received infrared light greater than a second light intensity threshold are disposed around the first receiver with the intensity of the received infrared light being less than the first light intensity threshold. Herein, the second light intensity threshold is greater than the first light intensity threshold. For example, the second light intensity threshold is eight times to 20 times that of the first light intensity threshold, such as eight times, ten times, and the like.

As the pupil has a less capability of reflecting the infrared light and the iris has a greater capability of reflecting the infrared light, the intensity of the infrared light corresponding to the receiver receiving the infrared light reflected by the pupil is less (that is, less than the first light intensity threshold), and the intensity of the infrared light corresponding to the receiver receiving the infrared light reflected by the iris is greater (that is, greater than the second light intensity threshold). The data point with intensive energy of the reflected light around and weak energy of the reflected light in the center position is determined by comparing the data of the light intensity output by the receivers, and the receiver corresponding data point is ascended to acquire the position of the pupil.

In the case that the distance between the eyeball and the target object changes, for example to the second distance, the processing unit controls the first receiver corresponding to the second distance in the plurality of sub-units to receive the infrared light reflected by the eyeball, controls the second receiver in the plurality of sub-units other than the first receiver to not receive the infrared light reflected by the eyeball, and determines the position of the eyeball based on the intensity of the infrared light received by the first receiver, such that the position of the eyeball is tracked.

In some embodiments, the processing unit 40 is further configured to control the second receiver in the plurality of sub-units 30a to not receive the infrared light reflected by the eyeball. The second receiver is a receiver other than the first receiver, such as the white block in FIG. 2. The processing unit 40 controls the second receiver to not receive the infrared light reflected by the eyeball by not supplying the drive voltage to the diaphragm of the second receiver, such that the diaphragm of the second receiver is in the off state, and the second receiver does not receive the infrared light reflected by the eyeball. As it is not necessary to drive the diaphragm of the second receiver to work, the power consumption of the device for tracking eyeballs is further reduced. In addition, the diaphragm of the second receiver is closed, such that the effect of the stray light is avoided.

In some embodiments, the processing unit 40 is further configured to control the second receiver in the plurality of sub-units 30a to receive the infrared light reflected by the eyeball. In processing the data, the processing unit 40 first screens out the intensity of the light corresponding to the first servicer corresponding to the first distance based on the corresponding relationship of the distance and the receiver, and then determines the position of the eyeball based on the intensity of the infrared light received by the first receiver.

In some embodiments, in the case that the target object includes a plurality of eyebox regions, the processing unit is further configured to determine the target eyebox region based on an eye portion position corresponding to the eyeball, such that the corresponding relationship of the plurality of sub-regions and the plurality of sub-units in the target eyebox region.

In the embodiments of the present disclosure, the eye portion position is determined based on the image shot by the camera. In this case, the device for tracking eyeballs further includes an eye portion position determining unit for determining the eye portion position. The eye portion position determining unit includes a camera, and the like. The camera is configured to shot the image within the viewing region of the display screen, and then determine the position of the eye portion of the viewer in a plana perpendicular to the optical axis of the display screen based on the image.

The above embodiments are described by taking the position of the eyeball being the position of the eyeball in the eyebox region as an example. In some embodiments, the position of the eyeball is the gazing position of the eyeball on the display screen. As the corresponding relationship exists between the sub-regions in the eyebox region and the display sub-regions in the display region of the display screen, that is, the image displayed in the corresponding display sub-region is emphasized in the case that the eye is in the sub-region in the eyebox region, the method further includes: determining the gazing position of the eyeball on the display screen based on the corresponding relationship of the sub-regions in the eyebox region and the display sub-regions in the display region of the display screen.

Alternatively, the corresponding relationship of the sub-units and the display sub-regions is established based on the corresponding relationship of the sub-regions in the eyebox region and the sub-units and the corresponding relationship of the sub-regions in the eyebox region and the display sub-regions in the display region of the display screen, and then the gazing position of the eyeball on the display screen is directly determined based on the position of the pupil and the corresponding relationship of the sub-units and the display sub-regions.

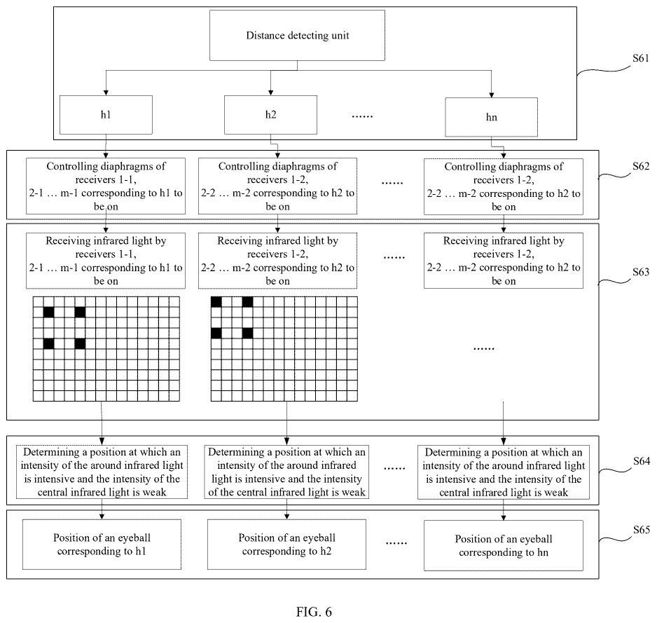

FIG. 6 is a schematic diagram of a working process of a device for tracking eyeballs according to some embodiments of the present disclosure. As shown in FIG. 6, the working process includes the following processes. In S61, the distance detecting unit detects the distance between the eye and the target object, for example, h1, h2 . . . hn. In S62, the processing unit controls the diaphragm of the receiver corresponding to the target distance to be on, for example, the receiver 1-1, 2-1 . . . m-n corresponding to the distance h1, the receiver 2-1, 2-2 . . . 2-n corresponding to the distance h2, and so on. In S63, the sensor of the receiver corresponding to the target distance receives the infrared light, one part of sensors corresponding to the target distance receives intensive infrared light (for example, the receiver shown in the black block in FIG. 6), and the other part of sensors receives weak infrared light (almost none). In S64, the processing nit determines the position at which the intensity of the around infrared light is intensive and the intensity of the central infrared light is weak. In S65, the processing unit determines the position of the eyeball at the target distance based on the position.

FIG. 7 to FIG. 9 are schematic diagram of working principles of a device for tracking eyeballs at different distances according to some embodiments of the present disclosure.

As shown in FIG. 7, in the case that the distance between the human and the display screen is L1, the distance output by the distance detecting unit to the processing unit is L1. The processing unit controls the diaphragm of the receiver corresponding to the distance L1 in the sub-unit to be on, and the diaphragm of the other diaphragms of the receiver to be off. The sensor of the receiver corresponding to the distance LI receives the infrared light, and the processing unit determines the position of the eyeball based on the infrared light received by the receiver corresponding to the distance L1.

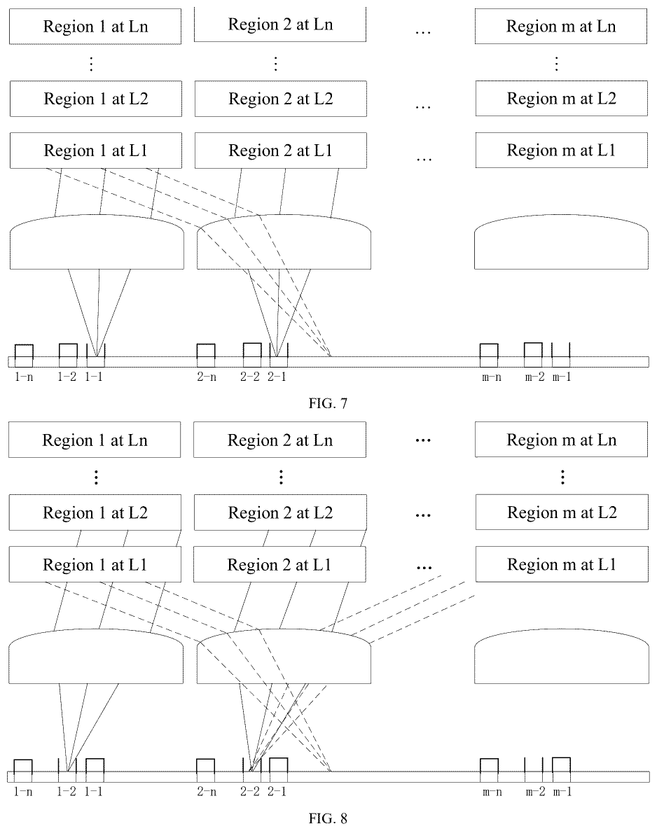

As shown in FIG. 8, in the case that the distance between the human and the display screen is L22, the distance output by the distance detecting unit to the processing unit is L22. The processing unit controls the diaphragm of the receiver corresponding to the distance L22 in the sub-unit to be on, and the diaphragm of the other diaphragms of the receiver to be off. The sensor of the receiver corresponding to the distance L2 receives the infrared light, and the processing unit determines the position of the eyeball based on the infrared light received by the receiver corresponding to the distance L2.

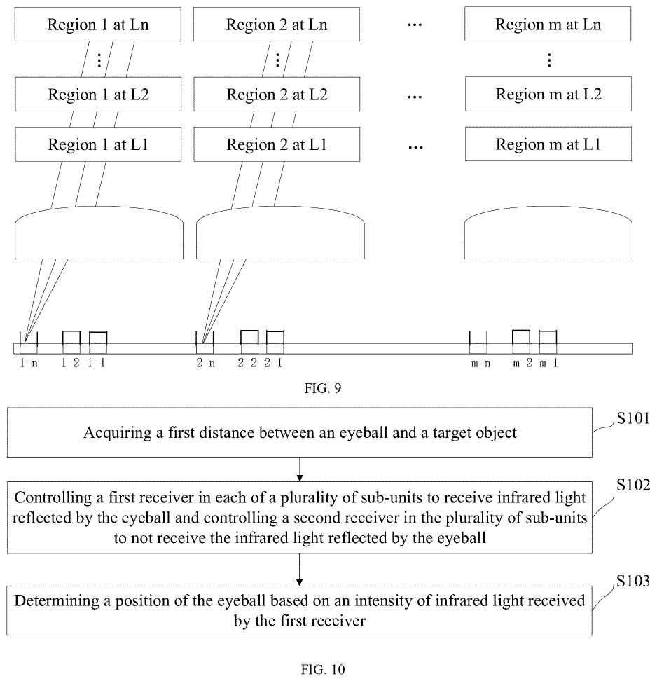

As shown in FIG. 9, in the case that the distance between the human and the display screen is Ln, the distance output by the distance detecting unit to the processing unit is Ln. The processing unit 40 controls the diaphragm of the receiver corresponding to the distance Ln in the sub-unit to be on, and the diaphragm of the other diaphragms of the receiver to be off. The sensor of the receiver corresponding to the distance Ln receives the infrared light, and the processing unit determines the position of the eyeball based on the infrared light received by the receiver corresponding to the distance Ln.

It can be seen from FIG. 7 to FIG. 9 that, for the plurality of receivers corresponding to the distance, some of the plurality of receivers receive the infrared light, and the other of the plurality of receivers does not receive the infrared light. For example, in FIG. 7, the receivers 1-1 and 2-1 receive the infrared light, and the receiver m-1 does not receive the infrared light. In FIG. 8, the receivers 1-2 and 2-2 receive the infrared light, and the receiver m-2 does not receive the infrared light.

In addition, it can be further from FIG. 7 to FIG. 9 that, receivers corresponding to different distances in each sub-unit are different. For example, in FIG. 7, the receivers corresponding to the distance L1 are 1-1, 2-1 . . . m-1. In FIG. 8, the receivers corresponding to the distance L2 are 1-2, 2-2 . . . m-2. In FIG. 9, the receivers corresponding to the distance L1 are 1-n, 2-n . . . m-n. m represents m^{th} sub-unit.

It should be noted that in FIG. 7 to FIG. 9, the distance between the receivers are exemplar.

The embodiments of the present disclosure further provide a method for tracking eyeballs. The method for tracking eyeballs is performed by the above processing unit. FIG. 10 is a flowchart of a method for tracking eyeballs according to some embodiments of the present disclosure. As shown in FIG. 10, the method includes the following processes.

In S101, a first distance between an eyeball and a target object is acquired.

The first distance is acquired by the above distance detecting unit.

In S102, a first receiver in each of a plurality of sub-units is controlled to receive infrared light reflected by the eyeball.

The plurality of sub-units are arranged in an array, any of the plurality of sub-units includes a plurality of receivers arranged in an array, and the first receiver is a receiver in the plurality of sub-units corresponding to the first distance.

In some embodiments, S102 further includes: controlling a second receiver in the plurality of sub-units to not receive the infrared light reflected by the eyeball, and the second receiver is a receiver other than the first receiver.

In S103, a position of the eyeball is determined based on an intensity of infrared light received by the first receiver.

In some embodiments, S103 includes: a first step, determining a position of a pupil of the eyeball based on the intensity of the infrared light received by the first receiver; and a second step, determining a target sub-region corresponding to the sub-unit of the position of the pupil as the position of the eyeball based on a corresponding relationship of the plurality of sub-units and the plurality of sub-regions.

Illustratively, in the first step, determining a position of the first receiver meeting the following conditions as the position of the pupil: the intensity of the received infrared light is less than a first light intensity threshold, and a plurality of first receivers with the intensity of the received infrared light greater than a second light intensity threshold are disposed around the first receiver with the intensity of the received infrared light being less than the first light intensity threshold.

In the case that the distance between the eyeball and the target object change, for example, to a second distance, the first receiver corresponding to the second distance in the plurality of the sub-units is controlled to receive the infrared light reflected by the eyeball, the second receiver in the plurality of the sub-units other than the first receiver is controlled to not receive the infrared light reflected by the eyeball, and the position of the eyeball is determined based on the intensity of the infrared light received by the first receiver, such that the position of the eyeball is tracked.

In the case that the display screen of the target object includes a plurality of eyebox regions, the method further includes: determining the target eyebox region based on an eye portion position corresponding to the eyeball.

It should be noted that the method for tracking eyeballs and the device for tracking eyeballs are the same concept, and the related descriptions are referred to the above device for tracking eyeballs, which is omitted herein.

The embodiments of the present disclosure further provide a display device. As shown in FIG. 3, the display device includes: a display screen b and any of the device for tracking eyeballs in the above embodiments.

In some embodiments, the light emitting unit includes a plurality of LEDs arranged at intervals around the display region b1 of the display screen b.

In some embodiments, the display device is an autostereoscopic display, an AR device, or a VR device. The AR device includes, but is not limited to the head up AR device (for example, the AR glasses, the AR helmet and the like) or HUD, and the like. Alternatively, the display device is a terminal with the display function, for example, the mobile phone, the tablet, the desktop monitor, the laptop, and the like.

In some embodiments, the light detecting unit 30 is disposed on a central position of a first side edge of the display screen b.

Illustratively, the type of the display screen b is not limited in the embodiments of the present disclosure, for example, a liquid crystal display screen, an organic light emitting diode (OLED) display screen, an LED display screen, a micro-OLED display screen, a mini-OLED display screen, and the like.

The embodiments of the present disclosure further provide an apparatus for tracking eyeballs. As shown in FIG. 11, the apparatus 1100 for tracking eyeballs includes an acquiring module 1101, a controlling module 1102 and a determining module 1103. The acquiring module 1101 is configured to acquire a first distance between an eyeball and a target object. The controlling module 1102 is configured to control a first receiver in a plurality of sub-units to receive infrared light reflected by the eyeball and a second receiver in the plurality of sub-units to not receive the infrared light reflected by the eyeball. The plurality of sub-units are arranged in an array, any of the plurality of sub-units includes a plurality of receivers arranged in an array, the first receiver is a receiver in the plurality of sub-units corresponding to the first distance, and the second receiver is a receiver in the plurality of sub-units other than the first receiver. The determining module 1103 is configured to determine a position of the eyeball based on an intensity of infrared light received by the first receiver.

In some embodiments, the determining module 1103 includes a pupil position determining sub-module 11031 and an eyeball position determining sub-module 11032. The pupil position determining sub-module 11031 is configured to determine a position of a pupil of the eyeball based on the intensity of the infrared light received by the first receiver. The eyeball position determining sub-module 11032 is configured to determine a target sub-region corresponding to the sub-unit of the position of the pupil as the position of the eyeball based on a corresponding relationship of the plurality of sub-units and the plurality of sub-regions.

Illustratively, the pupil position determining sub-module 11031 is configured to determine a position of the first receiver meeting the following conditions as the position of the pupil: the intensity of the received infrared light is less than a first light intensity threshold, and a plurality of first receivers with the intensity of the received infrared light greater than a second light intensity threshold are disposed around the first receiver with the intensity of the received infrared light being less than the first light intensity threshold.

In the case that the display screen of the target object includes a plurality of eyebox regions, the determining module 1103 is further configured to determine the target eyebox region based on an eye portion position corresponding to the eyeball.

It should be noted that the eyeball tracking of the device for tracking eyeballs in the embodiments is illustrated by taking the all division of the functional modules as an example. In actual implementations, the above functions are achieved by different functional modules as required, that is, the internal structure of the device is divided into different functional modules to achieve all or part of the functions described above. In addition, the apparatus for tracking eyeballs and the method for tracking eyeballs are the same concept, and the detailed implementations are referred to the embodiments of the device and the method for tracking eyeballs, which is not repeated herein.

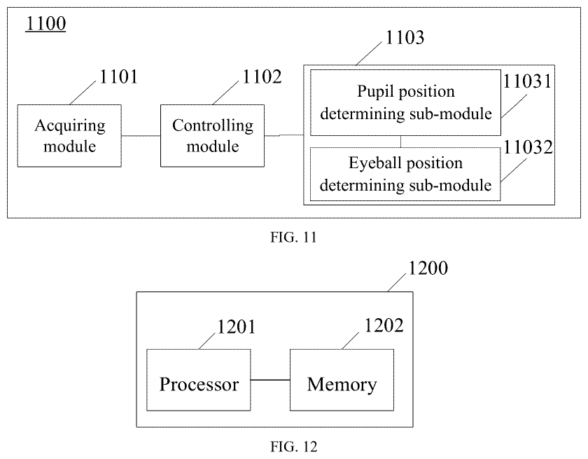

FIG. 12 is a schematic structural diagram of a computer device according to some embodiments of the present disclosure. As shown in FIG, 12, the computer device 1200 includes a processor 1201 and a memory 1202.

The processor 1201 includes one or more processing cores, for example, a five-core processor, an eight-core processor, or the like. In some embodiments, the processor 1201 is implemented by at least one hardware of a digital signal processor (DSP), a field-programmable gate array (FPGA), and a programmable logic array (PLA). In some embodiments, the processor 1201 further includes a primary processor and a secondary processor. The primary processor is a processor configured to process data in an active state, and is also referred to as a central processing unit (CPU). The secondary processor is a low-power consumption processor configured to process data in a standby state.

The memory 1202 includes one or more computer-readable storage media, and the computer-readable storage medium is non-transitory. In some embodiments, the memory 1202 further includes a high-speed random-access memory, and a non-volatile memory, for example, one or more magnetic disk storage devices or flash storage devices. In some embodiments, the non-transitory computer-readable storage medium in the memory 1202 is configured to store at least one instruction. The at least one instruction, when loaded and executed by the processor 1201, causes the processor 1201 to perform the method for tracking eyeballs according to the embodiments of the present disclosure.

It should be understood by those skilled in the art that the structure shown in FIG. 12 are not intend to limit the computer device 1200, and the computer device 1200 may include more or less assemblies, be combined with other assemblies, or be provided with different assemblies.

In some embodiments of the present disclosure, a non-transitory computer-readable storage medium is provided. The instructions stored in the storage medium, when loaded and run by a processor, cause the processor to perform the method for tracking eyeballs in the embodiments of the present.

In some embodiments of the present disclosure, a computer program product is provided. The computer program product incudes computer programs/instructions. Wherein the computer programs/instructions, when loaded and run/executed by a processor, cause the processor to perform any above method for tracking eyeballs.

Unless otherwise defined, technical or scientific terms used herein shall have ordinary meaning understood by persons of ordinary skill in the art to which the disclosure belongs. The terms “first,” “second,” “third,” and the like used in the embodiments of the present disclosure are not intended to indicate any order, quantity or importance, but are merely used to distinguish the different components. The terms “a,” “an” and the like are also not intended to indicate the quantity limitation, and should be understood to include one or at least one. The terms “comprise” or “include” and the like are used to indicate that the element or object preceding the terms covers the element or object following the terms and its equivalents, and shall not be understood as excluding other elements or objects.

The above descriptions are not intended to limited the present disclosure in any manner. Although the present disclosure is described by the above embodiments, the embodiments are not intended to limit the present disclosure. Any many other equivalent embodiments without departing from the scope of the protection of the technical solutions of the present disclosure can be achieved by persons skilled in the art based on the above descriptions, and all contents without departing from the technical solutions of the present disclosure and any simple modifications, equivalent changes and substitutions are within the scope of protection of the technical solutions of the present disclosure.

1. A device for tracking eyeballs, comprising: a distance detecting unit, a light emitting unit, a light detecting unit, and a processing unit; wherein
the distance detecting unit is configured to detect a first distance between an eyeball to a target object;
the light emitting unit is configured to irradiate a target eyebox region of the target object with infrared light;
the light detecting unit comprises a plurality of sub-units arranged in an array, wherein each of the plurality of sub-units comprises a plurality of receivers arranged in an array, the plurality of receivers being configured to receive infrared light reflected by the eyeball; and
the processing unit is configured to control a first receiver in each of the plurality of sub-units to receive the infrared light reflected by the eyeball and determine a position of the eyeball based on an intensity of the infrared light received by the first receiver, wherein the first receiver is a receiver corresponding to the first distance.

2. The device for tracking eyeballs according to claim 1, wherein each of the plurality of receivers comprises a diaphragm and an infrared light sensor, wherein the diaphragm is configured to control whether to allow the infrared light to enter the corresponding infrared light sensor under the control of the processing unit.

3. The device for tracking eyeballs according to claim 2, wherein the diaphragm is a liquid crystal diaphragm or a micro electron scanning microscope.

4. The device for tracking eyeballs according to claim 1, wherein
each of the plurality of sub-units comprises an equal number of receivers with the same arrangement pattern; and
in at least two of the plurality of sub-units, arrangement positions of the receivers corresponding to the same distance are the same or different.

5. The device for tracking eyeballs according to claim 4, wherein each of the plurality of sub-units further comprises a micro-lens configured to converge the infrared light reflected by the eyeball to the first receiver in the each of the plurality of sub-units.

6. The device for tracking eyeballs according to claim 4, wherein each of the plurality of sub-units further comprises a light blocking structure disposed between any two adjacent receivers of the plurality of receivers.

7. The device for tracking eyeballs according to claim 1, wherein
the target eyebox region comprises a plurality of sub-regions arranged in an array; and
the processing unit is configured to determine a position of a pupil of the eyeball based on the intensity of the infrared light received by the first receiver, and determine a target sub-region corresponding to the sub-unit of the position of the pupil as the position of the eyeball based on a corresponding relationship of the plurality of sub-units and the plurality of sub-regions.

8. The device for tracking eyeballs according to claim 7, wherein the processing unit is configured to determine a position of the first receiver meeting the following conditions as the position of the pupil:
the intensity of the received infrared light is less than a first light intensity threshold, and a plurality of first receivers with the intensity of the received infrared light greater than a second light intensity threshold are disposed around the first receiver with the intensity of the received infrared light being less than the first light intensity threshold.

9. The device for tracking eyeballs according to claim 8, wherein
the target object comprises a display screen and is provided with a plurality of eyebox regions arranged in a direction parallel to a horizontal central line of the display screen, and the target eyebox region is one of the plurality of eyebox regions; and
the processing unit is further configured to determine the target eyebox region based on an eye portion position corresponding to the eyeball.

10. The device for tracking eyeballs according to claim 1, wherein the processing unit is further configured to control a second receiver in the each of the plurality of sub-units to not receive the infrared light reflected by the eyeball, wherein the second receiver is a receiver other than the first receiver.

11. A method for tracking eyeballs, comprising:
acquiring a first distance between an eyeball and a target object;
controlling a first receiver in each of a plurality of sub-units to receive infrared light reflected by the eyeball, wherein the plurality of sub-units are arranged in an array, each of the plurality of sub-units comprises a plurality of receivers arranged in an array, and the first receiver is a receiver in the each of the plurality of sub-units corresponding to the first distance; and
determining a position of the eyeball based on an intensity of the infrared light received by the first receiver.

12. The method for tracking eyeballs according to claim 11, wherein
the target eyebox region comprises a plurality of sub-regions arranged in an array; and
determining the position of the eyeball based on the intensity of the infrared light received by the first receiver comprises:
determining a position of a pupil of the eyeball based on the intensity of the infrared light received by the first receiver; and
determining a target sub-region corresponding to the sub-unit of the position of the pupil as the position of the eyeball based on a corresponding relationship of the plurality of sub-units and the plurality of sub-regions.

13. The method for tracking eyeballs according to claim 12, wherein determining the position of the pupil of the eyeball based on the intensity of the infrared light received by the first receiver comprises:
determining a position of the first receiver meeting the following conditions as the position of the pupil:
the intensity of the received infrared light is less than a first light intensity threshold, and a plurality of first receivers with the intensity of the received infrared light greater than a second light intensity threshold are disposed around the first receiver with the intensity of the received infrared light being less than the first light intensity threshold.

14. The method for tracking eyeballs according to claim 12, wherein
the target object comprises a display screen and is provided with a plurality of eyebox regions arranged in a direction parallel to a horizontal central line of the display screen, and the target eyebox region is one of the plurality of eyebox regions; and
the method further comprises:
determining the target eyebox region based on an eye portion position corresponding to the eyeball.

15. A display device, comprising: a display screen and a device for tracking eyeballs, wherein the device for tracking eyeballs comprises: a distance detecting unit, a light emitting unit, a light detecting unit, and a processing unit; wherein
the distance detecting unit is configured to detect a first distance between an eyeball to a target object;
the light emitting unit is configured to irradiate a target eyebox region of the target object with infrared light;
the light detecting unit comprises a plurality of sub-units arranged in an array, wherein each of the plurality of sub-units comprises a plurality of receivers arranged in an array, the plurality of receivers being configured to receive infrared light reflected by the eyeball; and
the processing unit is configured to control a first receiver in each of the plurality of sub-units to receive the infrared light reflected by the eyeball and determine a position of the eyeball based on an intensity of the infrared light received by the first receiver, wherein the first receiver is a receiver corresponding to the first distance
the light emitting unit and the light detecting unit are disposed on a periphery of a display region of the display screen.

16. The display device according to claim 15, wherein the display device is an autostereoscopic display, an augmented reality AR device, or a virtual reality VR device.

17. The display device according to claim 15, wherein the light emitting unit comprises a plurality of light emitting diodes LED arranged at intervals around the display region of the display screen.

18. The display device according to claim 15, wherein the light detecting unit is disposed on a central position of a first side edge of the display screen.

19. A computer device, comprising: a processor and a memory configured to store a computer program, wherein the processor, when loading and running the computer program in the memory, is caused to perform the method for tracking eyeballs as defined in claim 11.

20. A non-transitory computer-readable storage medium, comprising: at least one instruction, wherein the at least one instruction, when loaded and executed by a processor, causes the processor to perform the method for tracking eyeballs as defined in claim 11.
